(19) United States
(12) Patent Application Publication
(10) Pub. No.: US 2021/0264733 A1
(43) Pub. Date: Aug. 26, 2021

(54) METHOD OF VIRTUAL SPORTS GAMBLING BETWEEN ENTITIES PERFORMING IN SEPARATE REAL-WORLD EVENTS

(71) Applicant: SC IP LIMITED, St. Helier (JE)

(72) Inventor: Karen Umityan, San Gwann (MT)

(21) Appl. No.: 17/197,185

(22) Filed: Mar. 10, 2021

Related U.S. Application Data
(63) Continuation of application No. 16/499,191, filed on Sep. 27, 2019, now abandoned.

(51) Int. Cl. G07F 17/32

(52) U.S. Cl. CPC G07F 17/3276; G07F 17/3288

(57) ABSTRACT

A method of gambling. The method comprises the following steps: a computer system in communication with at least a first external data source, receives in real time at least some of a first data which represent one or more discrete occurrences commonly occurring in a first real-world event involving at least two entities. The computer system also receives in real time second data from the first or a second data source which represent of one or more discrete occurrences from a second real-world event involving at least two entities. The second data represents one or more discrete occurrences of the same general kind as that represented by the said first data. A game generator unit which, when provided with details of the entities and the real-world events they are involved in, generates a set of one or more virtual events between at least one of the entities involved in the first real-world event, and one of the entities involved in the second real-world event. The game generator unit then compiles a set of one or more wagers each having an odds value for each said virtual event. The wagers involve an outcome comprising at least one of an additive or comparative measure of discrete occurrences having occurred in the respective first and second real-world events but reattributed the virtual event and/or the respective entities involved in said virtual event.

### RELATED APPLICATIONS

The present application is a continuation of U.S. patent application Ser. No. 16/499,191 filed Sep. 27, 2019 with a docket number of 4428-002.PCT.US, which is a 371 nationalization of PCT/EP2017/057463 filed Mar. 29, 2017, the entire specifications of which are hereby incorporated by reference in their entirety for all purposes.

### FIELD OF THE INVENTION

This invention relates to an enhanced method of gambling, and more particularly to a method of gambling which increases the variety and number of possible bets available to users of the system.

### BACKGROUND OF THE INVENTION

The majority of modern gambling systems are either terminal-based or platform-based. A terminal-based gambling system most usually consists of a physical upright terminal and comprises a display screen, which is often touch sensitive and thus additionally provides a user interface for the terminal, and possibly various physical buttons, and perhaps coin, note and credit card receiving facilities by means of which users can provide the funds which they are prepared to wager. Of course, such terminals will all possess appropriate internal hardware, most commonly a processing apparatus, and operating and application software for execution thereon and therein.

A platform-based gambling system on the other hand is one in which the majority of the system is provided by, and hosted on hardware to which users gain access over the internet from any of a variety of different devices, such as traditional desktop computers, tablets, and increasingly commonly, smart devices. The platform may be considered to comprise both the hardware and the software, and in some cases might also be considered as extending to the infrastructure, but it is useful in this instance to consider the platform as being predominantly software in nature, because it is the software which causes the display of wager information on whatever device the user has connected to the platform with. Thus it will be readily understood by the skilled reader that a terminal-based gambling system is effectively largely or completely self-contained and is not connected over a computer network (although of course it may be), resembling most simply the traditional slot machine operated by a single user, whereas the platform-based gambling system is adapted and intended for many hundreds or thousands of simultaneous users.

Gambling systems creators are continually improving and proliferating their product offerings, and more recently, various virtual betting systems have been developed wherein the terminal or the platform can display or provide a representation of an event which is entirely virtual or fictitious. For example, virtual horse racing and virtual dog racing systems have been developed in which the display of the event itself to the user, whether on a terminal screen or over the internet, is essentially a visual representation of a computerised random number draw. As the reader will appreciate, a simplistic visual representation of such a computerised random number draw is largely without play value or capable of providing any engaging enjoyment for the user, but by combining the underlying relatively simple computer-generated outcomes with, for example, a graphical animation of a horse or dog race, a user is more engaged in the overall gambling process, and thus enticed to repeat the wager.

Virtual football gambling has also been proposed, wherein users can access entire virtual leagues of multiple virtual football teams whose players and their characteristics may be derived from real-world equivalents, so far as is possible, so as to create some form of database of statistics for each player, each team, and even possibly each league. This database provides a computer-readable measure of the relative qualities of players, teams, and the nature of the leagues they play in. By adopting such an approach, a virtual football league may directly correlate to a real-world equivalent, but of course, it is entirely possible for the system creators to provide one or more entire virtual leagues consisting of entirely fictitious teams. Once the virtual league has been created, the virtual gambling system (usually a platform-based system) then hosts the appropriate set of round-robin matches in the league, akin to a real-world football season, and in doing so also calculates the odds for each of the matches which will be played, usually incorporating a small rake for the system creator. The odds themselves, and indeed the system as a whole, are real in the sense that any user can deposit real-world funds into the system and then make a real wager on the virtual match at the calculated and displayed odds, and if the wager is successful, then user's account is credited accordingly. Despite the outcome of the match being determined exclusively by the system in an at least partially random manner, adapted as may be by some artificial intelligence (AI) component which utilises the database of statistics to provide more realistic outcomes more often, virtual football gambling is nevertheless engaging and entertaining, particularly as the user can be under the illusion that there is some skill involved in the gambling process.

In a similar manner to the virtual dog racing and virtual horse racing described above, it is possible for the system to display some graphical animation to the user during the time the virtual football match is in progress, and therefore provide some increased enjoyment for the user during his wager. It is worth mentioning that the actual duration of a virtual match hosted within the system is relatively short, typically of the order of a few minutes less, so that both the user's attention is retained, and he is frequently enticed to make repeat wagers.

A primary perceived disadvantage of virtual gambling systems is inherent in their very nature—some users are dissuaded from wagering in a system which, ostensibly or actually, has very little relation to real world events. Although for gambling systems providers, football matches lasting only two minutes are attractive because the enticement on the user to make repeat wagers is much more frequent, in reality, the majority of users do like their wager to have at least some basis in reality, even If this is only perceived, as for many gamblers, wagering on the outcome of a real-world event adds to the enjoyment of that event, especially if they are watching or listening to it live.

A further disadvantage of the very short duration of such virtual football matches is that they preclude a large proportion of the possible live or “in-play” wagers which can be made. The reader will no doubt be aware of the recent proliferation and success of in-play markets across a wide variety of sports, but particularly in football wherein users can not only place wagers, when the match is in progress, on the likely final number or count of a variety of on-pitch incidents (e.g. goals, corners, free kicks, red and yellow cards etc.) when the match finishes, they can also, if they consider it prudent to do so at the price offered by the gambling system, liquidate their earlier wagers in exchange for that price. The popularity and success of the In-play or live gambling market can, in part, be attributed to the increased engagement of the user in the sports game or match on which he has wagered, coupled with the increase in availability of live televised sporting events over recent years. Naturally, in a virtual gambling system where the virtual event is staged only for a relatively very short period of time, there little or no possibility for providing a live or in-play market.

Accordingly, it is an object of this invention to provide a user-accessible gambling system which combines the variety and possibilities of virtual gambling systems with real world events.

It is a further object of this invention to provide a gambling system based on virtual or fictitious events which have at least some real-world basis or component, and potentially therefore offer some possibilities for a live or in-play market while the virtual or fictitious event is in progress.

### SUMMARY OF THE INVENTION

According to the present invention there is provided a method of gambling comprising: receiving in real time, at a computer system in communication with at least a first external data source, at least some of a first data which represent one or more discrete occurrences commonly occurring in a first real-world event involving at least two entities; receiving in real time, at the computer system, second data from the first or a second data source which represent of one or more discrete occurrences from a second real-world event involving at least two entities, said second data representing one or more discrete occurrences of the same general kind as that represented by the said first data; generating a set of one or more virtual events between at least one of the entities involved in the first real-world event, and one of the entities involved in the second real-world event when provided with details of the entities and the real world events they are involved in; and compiling a set of one or more wagers each having an odds value for each said virtual event, said wagers involving an outcome comprising at least one of an additive or comparative measure of discrete occurrences having occurred in the respective first and second real-world events but reattributed to the virtual event and/or the respective entities involved in said virtual event.

Preferably, the invention is further characterised in that the odds value for one or more of the wagers compiled by the game generation unit is calculated using an original odds value for a corresponding wager available in or offered by the system prior to or during the time when the first real-world event is in progress and in respect of a similar outcome, said wager only being available to users before a time when both of the first and second real-world events have ended.

In one embodiment, it is preferred that the first and second real-world events run simultaneously, and in another it is preferred that they run consecutively.

Most preferably, each of the entities involved in the first and second real-world events are unique, but they need not be, and in a particular case, it is possible for the entities involved in the first real-world event to be the same as those competing against one another in the second real-world event, though of course in this case, the first and second real-world events would necessarily need to occur consecutively.

Most preferably, the total time a virtual event is considered as live or “in-play” is the time between the starting time of the first real-world event and the end-time of the second real-world event, the first real-world event being that which starts earlier in time than the second.

In a yet further preferred embodiment, the set of wagers compiled by the game generator unit and the respective odds therefore are considered as live or “in-play” for the entire period that the virtual event to which they relate is in progress.

In a most preferred embodiment the first and second real-world events are competitive events wherein the entities involved therein compete against one another for victory in the said real-world event.

Most preferably, the first and second real-world events are football matches, and the entities involved are football teams, but of course the invention can quite easily extend to any of a multitude of team and individual sports events in which two (or more) entities, whether teams or individuals, participate with the aim of securing victory over the other(s).

Most preferably, the discrete events represented by the data received by the system, when the first and second real-world events are football matches, comprise any of; a victory (or loss), a draw, a goal, a red/yellow card, a corner, a free kick, a goal kick or punt, a save, a shot on target or otherwise, a tackle, a missed tackle, a dribble, a pass, a stray or missed pass, a throw in, an offside decision, and combination of the above, qualified as may be by a relative or absolute time when they occurred in the context of the overall time of the event, or in terms of an absolute or relative position in terms of the field of play.

In a most preferred embodiment, the game generator unit automatically recalculates the odds for said one or more wagers in the set thereof when one of the following occurs: a predetermined time period elapses while the virtual event is in progress, such necessarily reducing the total live time remaining for the virtual event; or first and/or second data is received by said gambling system whereby it is notified that of one or more discrete occurrences being monitored by said system and used in the calculation of the odds for one or more of the wagers in the set thereof has occurred in one of the first and second real-world events.

Most preferably, said first data and said second data are received by said system in substantially real-time.

In a yet further preferred embodiment, said system is in communication with a first external data source and a second external data source, delivering respectively first data and second data to said system.

Thus, by creating virtual events which are based on, and indeed dependent on to a large extent, real-world events, it is possible to offer not only the known in-play or live market of wagers to the user in respect of both the first and second real-world event, but also to offer second (and further) sets of wagers broadly similar if not identical in nature and content to those being offered for the real-world events, but for the virtual events. Furthermore, where the first and second (and further) real-world events run consecutively, the set of wagers thus compiled can be offered as live or “in-play” over the entire time from the commencement of the first real-world event to the end of the last occurring real-world event.

A specific embodiment of the invention, provided by way of example only, will now be described with reference to the accompanying Figures wherein:

### BRIEF DESCRIPTION OF THE FIGURES

FIG. 1 shows a flow chart of the method of the present invention; and

FIG. 2 shows a schematic depiction of a gambling system according to the present invention.

### DETAILED DESCRIPTION

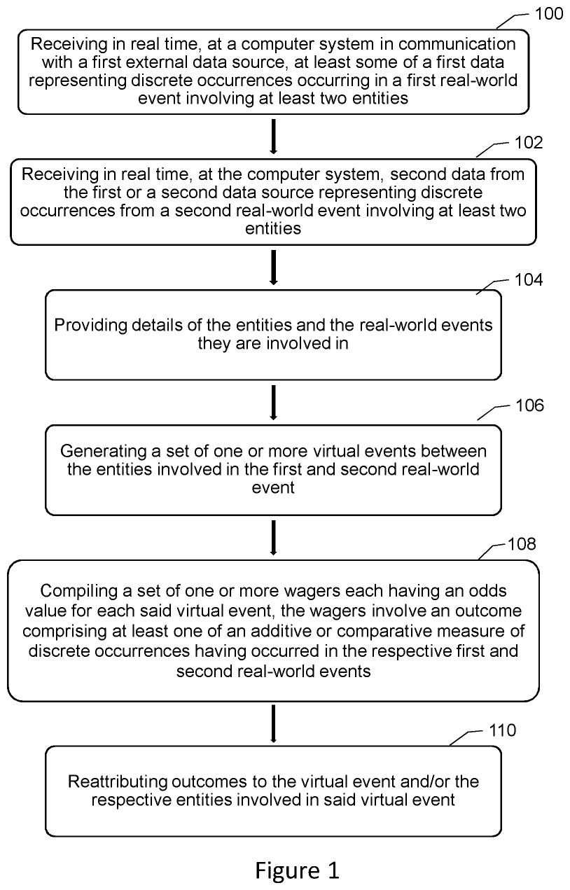

Referring firstly to FIG. 1, there is shown a flow chart of the method according to the present invention, comprising the following steps:

At step 100: Receiving in real time, at a computer system in communication with a first external data source, at least some of a first data representing discrete occurrences occurring in a first real-world event involving at least two entities;

At step 102: Receiving in real time, at the computer system, second data from the first or a second data source representing discrete occurrences from a second real-world event involving at least two entities;

At step 104: Providing details of the entities and the real-world events they are involved in;

At step 106: Generating a set of one or more virtual events between the entities involved in the first and second real-world event;

At step 108: Compiling a set of one or more wagers each having an odds value for each said virtual event, the wagers involve an outcome comprising at least one of an additive or comparative measure of discrete occurrences having occurred in the respective first and second real-world events;

At step 110: Reattributing outcomes to the virtual event and/or the respective entities involved in said virtual event.

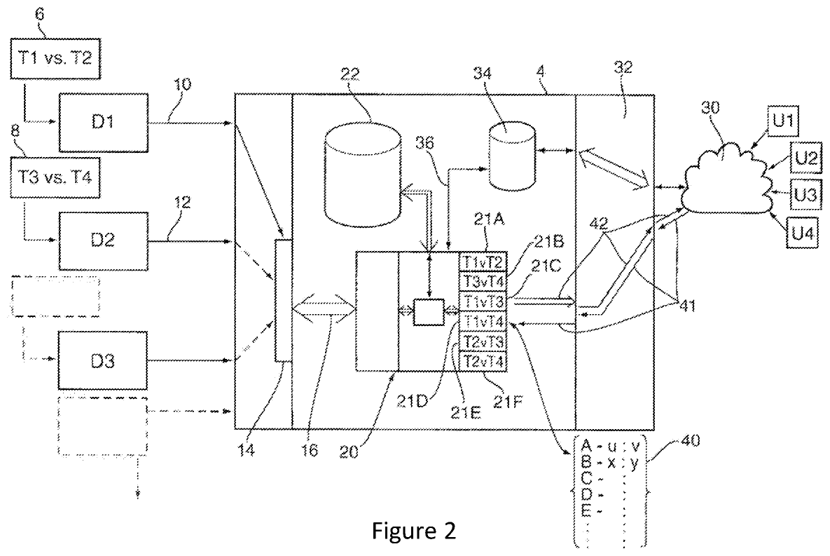

Turning now to FIG. 2, there is shown a gambling system indicated generally at 2 comprising a gambling platform 4 which will usually consist of, among other things, one or more elements of:
hardware (essentially processing units, possibly, in certain cases including dedicated, custom-designed hardware components such as Application-Specific Integrated Circuits or ASICs)
software (usually very high performance custom-built applications capable of delivering gambling content to multitudinous users on a variety of devices)
infrastructure components (switches, dedicated communications links, data buses, data delivery channels, and the like).

In the diagram however only schematic elements are included where such are considered necessary to illustrate the invention.

The gambling platform 4 relies firstly on the provision of substantially real-time data from external data sources, of which 3 are referenced at D1, D2, D3. There can of course be greater or fewer, but at least one is required to feed gambling platform 4 with real-time data from one or more live, real-world events indicated at 6, 8 between respective teams T1, T2 (6) and T3, T4 (8). A commercially available example of such substantially real-time data sources D1, D2 is provided by Opta (e.g. their Core, Classic, and Performance Data feeds), Live events 6, 8 may occur completely or partially simultaneously (one starting slightly after the other) or they may be scheduled consecutively, but in any event, a variety of different data is collected by a variety of different means at the venue of the live event and while it is in progress, and this is then streamed from the data source D1, D2 (or provider thereof) directly (or indirectly) to the gambling platform 4 as is known, and as is indicated at arrows. Within the platform 4 there is optionally provided some aggregation of the data as indicated at 14 before the data is forwarded at 16 to a game generator unit indicated generally at 20, in which it is subjected to some analysis and processing, it is worth mentioning at this stage that the data received from external data sources need not be continuous, although in many cases it will be. if the data is of relatively low resolution, for example if the discrete occurrences represented thereby are relatively infrequent (e.g. in a football context, only goals, corners and red cards are encoded within the data), then the data may be transmitted to the platform only sporadically only when any of the discrete occurrences being monitored actually occurs. Alternatively, the data may be of a very high resolution and represent practically every single discrete occurrence in the real-world event {e.g. in the football context, every kick/pass, every refereeing decision, including relative pitch location data providing information on where the event occurred on the pitch etc.).

For a conventional in-play or live gambling market, if the data received in the game generator unit 20 is representative of a discrete occurrence in any one of the current live events 6, 8 which has an impact on one or more of the live or “in-play” markets (indicated generally at 21 A, 21 B) currently being offered for that event by the gambling platform, e.g. in the football context, one team scores a goal thus impacting the odds of one or other team in the event winning, then game generator unit 20 makes appropriate automatic adjustments to the odds of all those in-play markets which might be affected (and by differing amounts as appropriate). In order to achieve this accurately and effectively, it is of course necessary to maintain some record of current odds values and the wagers to which they relate, among other things, and therefore gambling platform 4 includes a market data repository 22 to which information is continually or intermittently written by game generator unit, and which is continually or intermittently interrogated by said game generator unit.

Much of the above aspects of the platform 4 represent the private aspects thereof. In terms of the public access to the platform, users U1, U2, U3, U4 connect to the platform via the internet, and an access layer 32 provides requisite security and encryption. To enable content from the platform to be delivered safely to the users' devices. As is common, access layer 30 may interrogate a user account repository 34 during the user log-in process to ensure only registered users can access the platform. Additionally, game generator unit 20 may query the user account repository when it comes to users making wager requests for specific monetary amounts, as indicated generally at 36. in accordance with the invention, game generator unit also creates a set of virtual events 21C, 21D, 21E, 21F based to a greater or lesser extent on the real-world events 6, 8 at that time in progress or schedule later to occur, in one embodiment, the set of virtual events is all the unique combinations of the teams T1, T2, T3, T4 (including possible home and away variations, if the real-world events might involve a home advantage), other than the real-world events 8, 8, Hence, 21C-21F are represented schematically in the game generation engine as, respectively, T1 v T3, T1 v T4, T2 v T3, and T2 v T4.

The actual time of generation of these virtual events is less important, but in essence as soon as game generator unit is in possession of sufficient information to determine that teams T1 and T2 are scheduled to play one another at a particular time, and that either any two other teams are scheduled to play one at the same time or a later time, or that either or both of teams T1 and T2 are scheduled to play one another again after the completion of their first encounter, then game generator unit can commence the process of generating the virtual events. Furthermore, it is possible that the generation of the virtual events occurs as soon as game generator unit 20 receives sufficient-live data from any one or more of the data sources D1, D2. In this embodiment, the virtual events, the available set of wagers created therefor, may be packaged as a yet further alternative live or in-play market for real-world event.

In a most preferred embodiment, for each of the virtual events so created, the game generator unit additionally creates a set 40 of wagers which a user may wager real-world money against, through the conventional mechanism indicated by arrows 41. Most preferably, each of said wagers is of the type commonly found in conventional in-play or live gambling markets (e.g. in a football context, win/lose, total goals/corners/goal kicks/passes/red cards/yellow cards etc.). In a particularly preferred arrangement, the wagers offered are either comparative in nature (e.g. T3 will have a greater/less than number of goak/corners/goal kicks/passes etc.) than team T1 (or vice-versa), or they will be additive in nature (e.g. the total number of goals/corners/goal kicks/passes etc. for the virtual event between T1 and T3 will be 1, 2, 3, . . . , n). As can be seen within the set of wagers 40, each wager (A, B, C, D, E, will have an odds value u:v, x:y against it These are again calculated by the game generator unit 20 when the virtual event is defined or shortly thereafter, and offered to the user by conventional means, as indicated at arrows 42.

A specific example of the virtual creation process is now provided to further exemplify the invention. Retaining the football context, for example the following matches will kick off at the same time one Saturday afternoon:

Team1 (T1) vs Team2 (T2). This is real-world Game1.

Team3 (T3) vs Team4 (T4)—This is real-world Game2

The system will generate the following games:

Team1 vs Team4—Game1′

Team1 vs Team3—Game2′

Team2 vs Team3—Game3′

Team2 vs Team4—Game4′

Thus the game generator unit 20 generates four virtual games based on two real games. Virtual games can be generated across leagues, divisions, championships, even countries. For each virtual games, there is also created a set of possible wagers starting from the relatively simple (win, loose, red cards, yellow cards etc.) and ranging to the relatively complex (e.g. the total number of kicks/passes in the virtual game, total free kicks, and indeed any discrete event which both of the real teams in their respective real-world events are likely to accrue). In one embodiment, the wagers available for virtual games can be chosen only from the list of corresponding wagers available for the real-world games.

Ideally, the logic of calculation for the wagers available for the virtual games is one of the following two, or some combination thereof:

1. The absolute volume or total of particular discrete occurrences (e.g. goals, red cards, yellow cards etc.) which occur within the respective real-world game (e.g. total passes in the virtual game T1 v T3 equals some number or other), and

2. A Comparative (or difference) result of one team to the other (e.g. T1 makes more/less passes than T3).

For example, if the game Team1 vs Team2 finished with the result P1-P2, i.e. Team1 scored P1 goal(s) and Team2 scored P2 goal(s), then:

Team1 P1-P2 Team2

Expanding this principle to a further real-world game, the following result may be:

Team3 P3-P4 Team4

Using the first logic basis of calculation;

Team1 kicked P1 goal,

Team2 kicked P2 goal,

Team3 kicked P3 goal,

Team4 kicked P4 goal

By the 2nd logic of calculation:

Team1 won/lost by (P1-P2) goals,

Team2 won/lost by (P2-P1) goals,

Team3 won/lost by (P3-P4) goals,

Team4 won/lost (P4-P3) goals:

By this logic we can calculate both absolute FIG. (1st logic) and the comparative FIG. (2nd logic).

Take for example the virtual match Team1 vs Team4, and the wager selected is the total number of goals. According to the 1st logic of calculation, the result of the match is: Team1 P1-P4 Team4.

By comparing P1 and P4 it is possible to determine the final result of the virtual game.

Although the above description is provided in terms of matches involving only two teams, it is of course possible to extend the system to events involving multiple individuals or teams, and to generate the accordingly much larger set of virtual events based on the total number of competitors in the real-world events.

What is claimed is:

1. A method of gambling comprising:
receiving in real time, at a computer system in communication with at least a first external data source, at least some of a first data which represent one or more discrete occurrences commonly occurring in a first real-world event involving at least two entities;
receiving in real time, at the computer system, second data from the first or a second data source which represent of one or more discrete occurrences from a second real-world event involving at least two entities, said second data representing one or more discrete occurrences of the same general kind as that represented by the said first data;
generating a set of one or more virtual events between at least one of the entities involved in the first real-world event, and one of the entities involved in the second real-world event when provided with details of the entities and the real world events they are involved in; and
compiling a set of one or more wagers each having an odds value for each said virtual event, said wagers involving an outcome comprising at least one of an additive or comparative measure of discrete occurrences having occurred in the respective first and second real-world events but reattributed to the virtual event and/or the respective entities involved in said virtual event.

2. The method according to claim 1 further comprising calculating the odds value for one or more of the wagers compiled by the game generation unit using the original odds value for a corresponding wager available in or offered by the system prior to or during the time when the first real-world event is in progress and in respect of a similar outcome, said wager only being available to users before a time when both of the first and second real-world events have ended.

3. The method according to claim 1, wherein the first and second real-world events occur one of simultaneously and consecutively.

4. The method according to claim 1, wherein the entities involved in the first and second real-world events are unique.

5. The method according to claim 1, further comprising identifying a total time a virtual event is considered as live or “in-play” as a time between a starting time of the first real-world event and an end-time of the second real-world event, the first real-world event being that which starts earlier in time than the second.

6. The method according to claim 1, further comprising determining the set of one or more wagers compiled by a game generator unit and the respective odds therefor as live or “in-play” for an entire period that the virtual event to which they relate is in progress.

7. The method according to claim 1, wherein the first and second real-world events are competitive events wherein the entities involved therein compete against one another for victory in the said real-world event.

8. The method according to claim 1, further comprising automatically recalculating the odds for said one or more wagers in the set thereof, using a game generator unit, when one of the following occurs:
a predetermined time period elapses while the virtual event is in progress, such necessarily reducing the total live time remaining for the virtual event; or
first and/or second data is received by said gambling system whereby it is notified that of one or more discrete occurrences being monitored and used in the calculation of the odds for one or more of the wagers in the set thereof has occurred in one of the first and second real-world events.

9. The method according to claim 1, further comprising delivering said first data and second data from an first external data source and a second external data source respectively.

10. The method according to claim 1, wherein the first and second real-world events are football matches, and the entities involved are football teams.

11. The method according to claim 10, wherein the discrete occurrences represented by the data received by the gambling system comprise one or more of: a victory, a loss, a draw, a goal, a red/yellow card, a corner, a free kick, a goal kick, a punt, a save, a shot on target or otherwise, a tackle, a missed tackle, a dribble, a pass, a stray or missed pass, a throw in, an offside decision, and a combination of the above, qualified as may be by a relative or absolute time when the discrete occurrences occurred in a context of an overall time of the event, or in terms of an absolute or relative position in terms of a field of play on which the occurrence occurs.
